(19) United States
(12) Patent Application Publication
(10) Pub. No.: US 2012/0215591 A1
(43) Pub. Date: Aug. 23, 2012

(54) OPTIMIZING A PRINTER SYSTEM IN CONSIDERATION OF ENVIRONMENTAL LOAD

(75) Inventors: Kazuhito Akiyama, Tokyo (JP); Sanehiro Furuichi, Tokyo (JP); Masami Tada, Kanagawa (JP)

(73) Assignee: INTERNATIONAL BUSINESS MACHINES CORPORATION, Armonk, NY (US)

(21) Appl. No.: 13/461,895

(22) Filed: May 2, 2012

Related U.S. Application Data
(63) Continuation of application No. 13/237,206, filed on Sep. 20, 2011.

(30) Foreign Application Priority Data
Sep. 21, 2010 (JP) 2010-210581

(51) Int. Cl. G06Q 30/02; G06Q 40/00

(52) U.S. Cl. 705/7.35; 705/400

(57) ABSTRACT

A print server selects a printer system to execute a print job received from a client, the printer system selected from among a plurality of printer systems connected to the network, the print server comprising a basic information acquiring section that acquires, at predetermining timing, unit price calculation basic information on printer systems in operation including at least information on environmental load information from at least one of the plurality of printer systems and external computers, a unit price calculating section that calculates a print unit price for each printer system based on the acquired unit price calculation basic information, a storage section that stores the calculated unit price in association with identification information for identifying the printer system and a sending section that sends the print unit prices and the identities of the printer systems associated with the calculated unit prices to the client.

### CROSS-REFERENCE TO RELATED APPLICATIONS

This application is a continuation of U.S. patent application Ser. No. 13/237,206, filed Sep. 20, 2011, entitled “OPTIMIZING A PRINTER SYSTEM IN CONSIDERATION OF ENVIRONMENTAL LOAD”, now pending, which claims priority to Japanese Patent Application No. 2010-210581, filed Sep. 21, 2010, the disclosures of which are incorporated herein by reference.

### BACKGROUND

Various aspects of the present invention relate generally to an optimum printer system provided in consideration of environmental load including electric power saving, reduction in printing cost, reduction of carbon dioxide emissions, and so on in a cloud computing environment.

With the proliferation of cloud computing technology, business operators who provide services such as print services have been increasing. These print service providers help customers set printing conditions, which are utilized to print and deliver materials through service level agreements. The service level agreement of a print service typically specifies the service provider's obligations to print out and deliver desired data through a cloud server that fulfills the service level agreement.

Emission trading is a market-based approach used to control pollution by providing economic incentives for achieving reductions in the emissions of pollutants, such as carbon dioxide. An area (such as a country) is allotted a number of “pollution credits,” which can be traded with other areas on the emissions market. An area that has more pollutants can purchase the credits from areas that do not pollute as much and have extra credits not being used.

### BRIEF SUMMARY

According to various aspects of the present invention, print server selects a printer system to execute a print job received from a client, the printer system selected from among a plurality of printer systems connected to the network, the print server comprising a basic information acquiring section that acquires, at predetermining timing, unit price calculation basic information on printer systems in operation including at least information on environmental load information from at least one of the plurality of printer systems and external computers, a unit price calculating section that calculates a print unit price for each printer system based on the acquired unit price calculation basic information, a storage section that stores the calculated unit price in association with identification information for identifying the printer system and a sending section that sends the print unit prices and the identities of the printer systems associated with the calculated unit prices to the client.

### BRIEF DESCRIPTION OF THE SEVERAL VIEWS OF THE DRAWINGS

FIG. 1 is a block diagram schematically showing the configuration of a cloud printing system for providing an optimum printer system in consideration of environmental load, according to aspects of the present invention;

FIG. 2 is a block diagram showing an example of the configuration of a client using a central processing unit (CPU) in the cloud printing system of FIG. 1, according to aspects of the present invention;

FIG. 3 is a block diagram showing the configuration of a printer system used in the cloud printing system of FIG. 1, according to aspects of the present invention;

FIG. 4 is a functional block diagram of the cloud printing system of FIG. 1, according to aspects of the present invention;

FIG. 5 is an illustration of a printer system selection screen in the cloud printing system, according to aspects of the present invention;

FIG. 6 is a conceptual diagram showing a flow of information acquired to enable a unit price calculating section to calculate a print unit price in the cloud printing system, according to aspects of the present invention;

FIG. 7 is a graph illustrating an exemplary unit price calculation model, according to aspects of the present invention;

FIG. 8 contains graphs illustrating an exemplary case where multiple unit price calculation models are combined to determine one print unit price calculating model, according to aspects of the present invention;

FIG. 9 is a flowchart showing a procedure performed by a CPU of a print server in the cloud printing system, according to various aspects of the present invention;

FIG. 10 is a flowchart showing a procedure performed by the CPU of the client in the cloud printing system, according to aspects of the present invention; and

FIG. 11 is a flowchart showing a procedure performed by the CPU of the print server in the cloud printing system, according to aspects of the present invention.

### DETAILED DESCRIPTION

According to aspects of the present invention, a system is provided that implements an optimum printer system in consideration of environmental load, as specifically described below with reference to the accompanying drawings. In this manner, aspects of the present invention can be carried out in a variety of different modes and should not be limited to the content of description of any particular embodiment. Note that the same reference numerals are employed throughout to denote the same elements.

According to aspects of the present invention, a unit price for a print job (print unit price) is not only based on fixed costs but also reflects the effect on the environment (i.e., environmental load) of the print job. As such, the environmental load can be reflected in calculating a print unit price, so that a balance between the improvement of usability of resources of a service provider and reduction in environmental load on a user can be achieved. Further, the user can acquire print unit prices, on which the environmental load is reflected, at predetermined timing, e.g., periodically, and this enables the user to select the optimum printer system based on the acquired print unit prices.

A printing process based on the fixed costs and environmental load can be useful, for example, as CO₂ emissions trading becomes prevalent and smart grids and smart buildings become widespread. A print client can acquire print unit prices reflecting the environmental load at predetermined intervals, which enables a user to select the optimal printer system for a print job based on the acquired print unit prices.

As will be described in greater detail herein, the fixed costs associated with a print job can include factors such as, but not limited to, the number of print jobs per unit time, waiting time, the consumable maintenance cost (paper, toner, etc.), information on a job scheduling policy, etc. Correspondingly, exemplary information on the environmental load can include factors such as, but not limited to, the power consumption of the printer in different modes (off, power-saving, standby, printing, etc.); the percentage of power to the printer system generated from different power generation methods, such as nuclear fission, burning fossil fuels (coal, oil, natural gas, etc.), solar cells, geothermal, ocean thermal energy conversion, wind, water, and biomass (wood, waste, alcohol, etc.); carbon dioxide (“CO₂”) emissions released and the market value of those emissions trading on an emissions market; market value for electricity; taxation, including taxation on CO₂ emissions; etc. Additionally, information on the availability of resources may be taken into account when calculating the environmental load. Information related to the availability of resources include factors such as the time of day, time of year, weather conditions, etc.

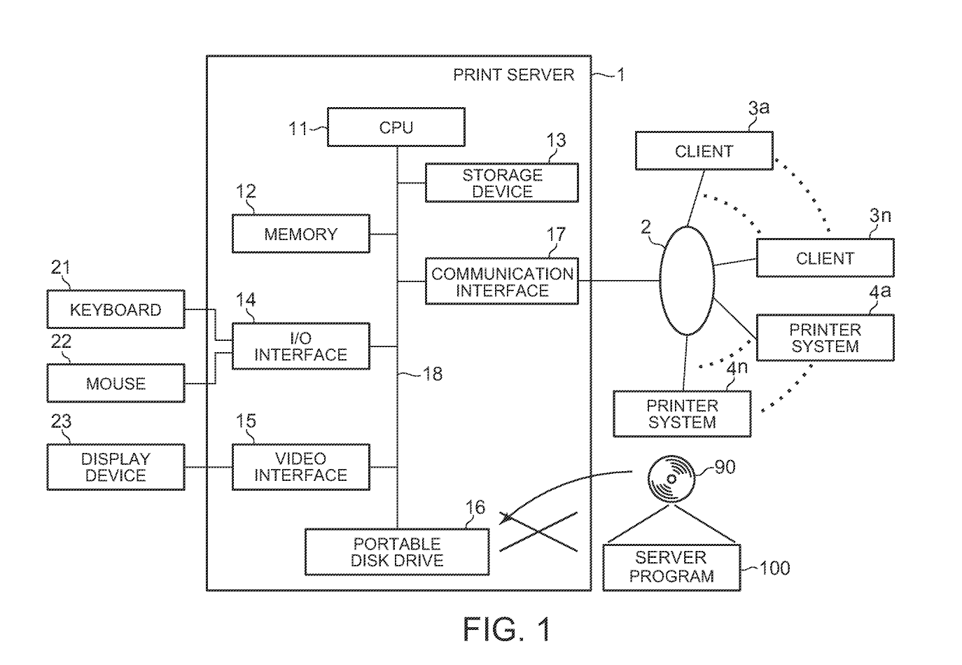

Turning now to the figures and in particular to FIG. 1, a block diagram schematically shows a configuration of a cloud printing system for providing an optimal printer system that takes environmental load into consideration. A print server 1 connects through a network 2 to multiple clients 3a, 3n, which are used by users to send a print job, and multiple printer systems 4, 4n, which are used by service providers who provide print services (i.e., printing service provider), to communicate data with each other.

The illustrated print server 1 includes a central processing unit (CPU) 11, a memory 12, a storage device 13, an input/output (I/O) interface 14, a video interface 15, a portable-disk drive 16, a communication interface 17, and an internal bus 18 connecting the above-mentioned hardware components, which are described in greater detail below.

The CPU 11 is connected to each of the above-mentioned hardware components through the internal bus 18 in the print server 1 not only to control the operation of each of the above-mentioned hardware components, but also to execute various functions of software according to a server program 100 stored in the storage device 13. The memory 12 is a volatile memory such as a static random-access memory (SRAM) or synchronous dynamic random-access memory (SDRAM). Upon running the server program 100, a load module is loaded into the memory 12 to store temporary data and the like generated during execution of the server program 100.

The storage device 13 is a non-volatile memory such as, but not limited to a built-in fixed type storage device (i.e., a hard disk), a read-only memory (ROM), etc. In an exemplary implementation, the server program 100 stored in the storage device 13 is downloaded from a portable recording medium 90, such as a DVD or a CD-ROM, on which the program and information such as data are recorded, through the portable disk drive 16. During execution, the server program 100 is loaded from the storage device 13 into the memory 12. As an alternative implementation, the server program 100 may be downloaded from an external computer connected to the network 2 through the communication interface 17.

In certain illustrative implementations, the system may acquire, from an external computer used by an external institution, unit price calculation basic information (hereinafter called basic information) necessary to calculate a print unit price for each printer system 4. By way of illustration, price calculation basic information may include information on a unit price calculation policy, information on the unit price of electric power, information on the unit price of CO₂ trading, and emission market price information. Price calculation basic information can also be read from the external computer and may be stored in the storage device 13.

The communication interface 17 is connected between the internal bus 18 and the network 2, such as the Internet, a local area network (LAN), or wide area network (WAN), so that the print server 1 can exchange data with the clients 3a, 3n, the printer systems 4a, 4n, external computers (not shown), etc.

The input output (I/O) interface 14 connects to data input (media) devices such as a keyboard 21 and a mouse 22. The video interface 15 connects to a display device 23 such as, but not limited to, a cathode ray tube (CRT) monitor or a liquid crystal display (LCD) to display given images.

Each client 3a . . . 3n can generate a print job capable of being executed in one of the printer systems 4a . . . 4n on behalf of a user who desires a printout. Each generated print job is accordingly sent to the print server 1.

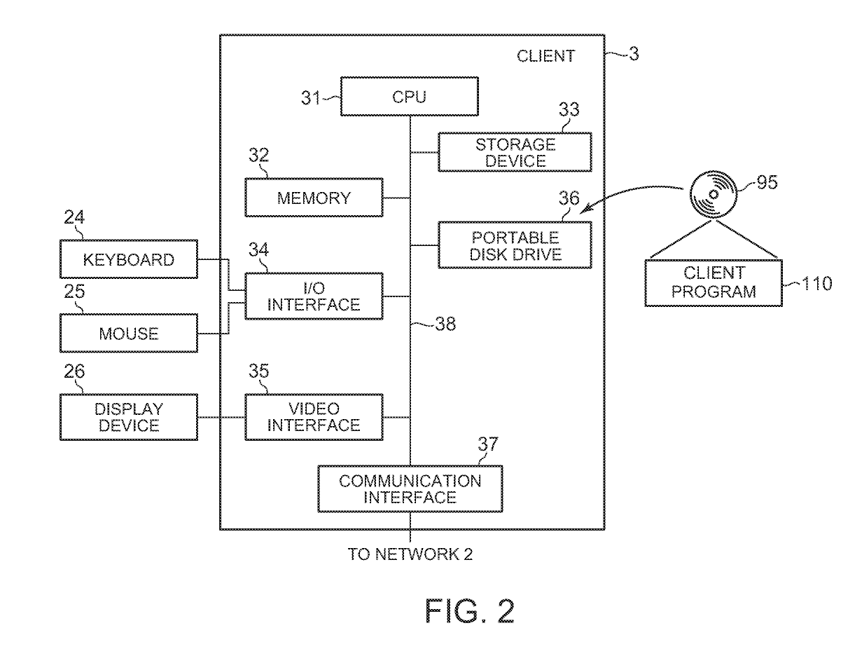

FIG. 2 is a block diagram showing an example of the configuration of a client 3 using a CPU in the cloud printing system according to aspects of the present invention. As illustrated, the client 3 is connected to be able to perform data communication with the print server 1 through the network 2.

The client 3 includes at least a CPU (Central Processing Unit) 31, a memory 32, a storage device 33, an I/O interface 34, a video interface 35, a portable disk drive 36, a communication interface 37, and an internal bus 38 connecting the above-mentioned hardware components.

The CPU 31 is connected to each of the above-mentioned hardware components through the internal bus 38 in the client 3 not only to control the operation of each of the above-mentioned hardware components, but also to execute various functions of software according to a client program 110 stored in the storage device 33. The memory 32 is a volatile memory such as SRAM or SDRAM. Upon running the client program 110, a load module is loaded into the memory 32 to store temporary data and the like generated during execution of the client program 110.

The storage device 33 is a non-volatile memory such as a built-in fixed type storage device (hard disk), a ROM, or the like. The client program 110 stored in the storage device 33 can be downloaded from a portable recording medium 95, such as a DVD or a CD-ROM, on which the program and information such as data are recorded, through the portable disk drive 36, and during the execution, loaded from the storage device 33 into the memory 32. Alternatively, the client program 110 may be downloaded from an external computer connected to the network 2 through the communication interface 37.

The communication interface 37 is connected between the internal bus 38 and the external network 2 (e.g., the Internet, LAN, or WAN) so that the client 3 can exchange data with the print server 1, external computers, and the like.

The I/O interface 34 connects to data input devices such as a keyboard 24 and a mouse 25 to accept input of data. The video interface 35 connects to a display device 26 such as a CRT monitor or an LCD to display given images.

Referring to FIGS. 1 and 2, each printer system 4a . . . 4n is connected to the print server 1 through the network 2 to be able to perform data communication to send the print server 1 basic information necessary to calculate a print unit price, such as the remaining amounts of consumables, operating status information, the toner price, the paper price, and the like. This basic information may be sent periodically at constant time intervals or each time a condition is updated, e.g., at the time of updating the toner price.

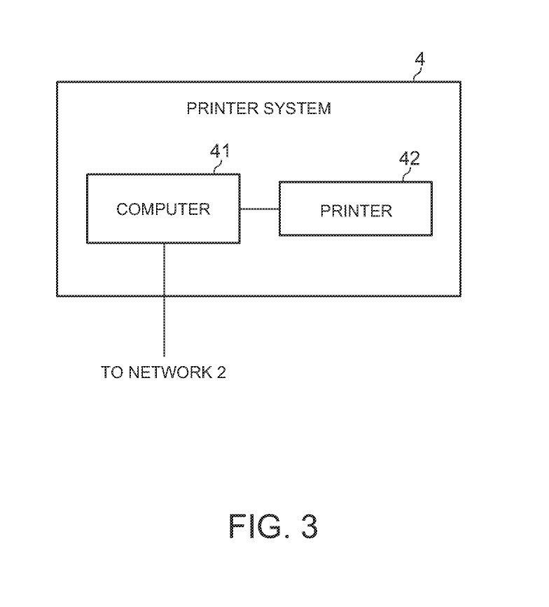

Referring to FIG. 3, a block diagram shows the configuration of a printer system 4 used in the cloud printing system according to aspects of the present invention. The printer system 4 is connected to be able to perform data communication with the print server 1 through the network 2.

The printer system 4 includes a printer 42 and a computer 41 for controlling the operation of the printer 42 and to extract the operating status of the printer 42. The computer 41 extracts basic information, such as the remaining amounts of consumables for the printer 42, information on the operating status, the price of toner used in the printer 42, and the paper price, necessary to calculate the print unit price and sends it to the print server 1 at predetermined timing.

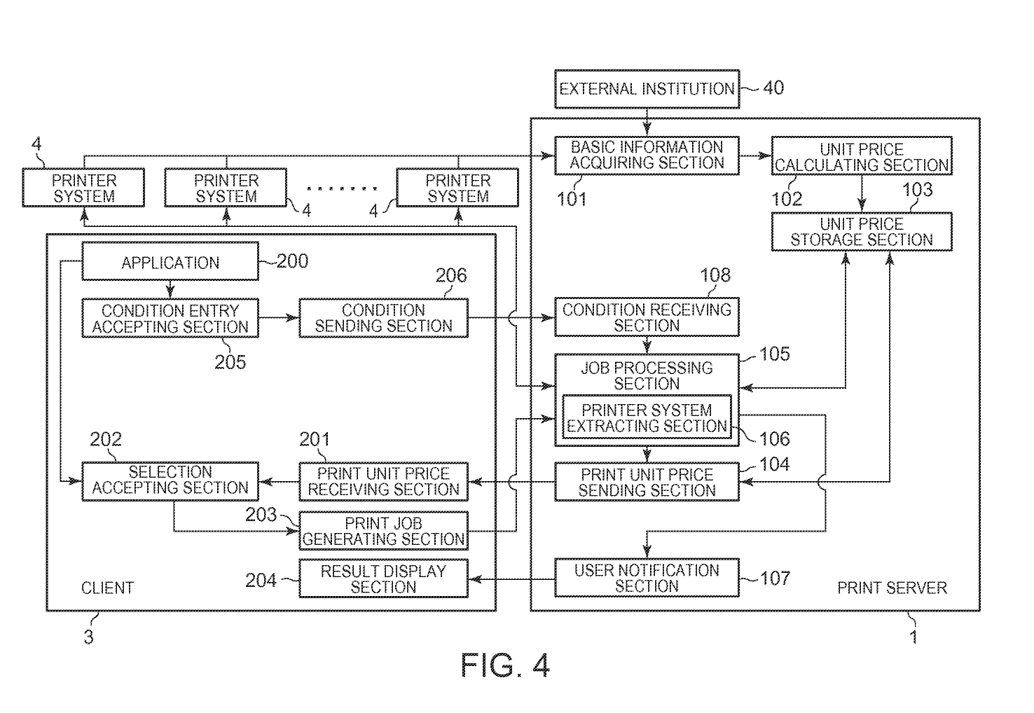

A method of selecting an optimal printer system 4 in the cloud printing system thus configured to execute a print job will be described below. Referring to FIG. 4, a functional block diagram of the cloud printing system is illustrated, according to aspects of the present invention.

In FIG. 4, a basic information acquiring section 101 of the print server 1 searches the printer systems 4 connected to be able to perform data communication through the network 2 or external computers used by external institutions 40 to acquire basic information necessary to calculate each print unit price. Basic information includes the remaining amounts of consumables for each of the printer systems 4 in which the service provider provides print services, information on the operating status, the toner price, and the paper price, and basic information necessary to calculate each print unit price in consideration of environmental load. The timing of acquiring the information is not particularly limited, but it is preferred to acquire the information periodically at constant time intervals (e.g., at intervals of one second) in order to calculate the print unit price on which the environmental load is reflected substantially in real time. Alternatively, the information may be acquired when any of the information is updated.

A unit price calculating section 102 calculates a print unit price for each printer system 4 based on the basic information acquired. The basic information includes the number of print jobs per unit time, waiting time, information on a job scheduling policy, the consumable maintenance cost, and the like, as well as information on the environmental load such as the power consumption on each printing condition and the percentage of each power generation method.

A point different from the conventional cloud printing systems is that the basic information to be acquired includes basic information necessary to calculate a print unit price in consideration of at least the environmental load. The basic information necessary to calculate a print unit price in consideration of the environmental load includes general information related to environmental protection. For example, consideration of environmental load may include the unit price of electric power for each power generation method, the unit price of electric power in each time slot, the market price of trading electricity, the market price of CO₂ emissions trading, weather information, taxation information, etc. For example, the basic information may include information about the percentage of a corresponding power generation method used in powering the printer system 4 acquired from the service provider to calculate a print unit price in response to changes in price substantially in real time.

In many cases, the basic information acquired from each printer system 4 indicates continuous values including predicted values varying with time. To be more specific, the continuous values are the print job execution cost including hardware depreciation costs used per print job, the unit price of electric power required per print job, CO₂ emissions per print job, a discount rate based on the printer availability, a cap on the CO₂ emissions, etc.

The print server 1 may also acquire necessary basic information from external institutions 40, such as electric power companies and CO₂ emissions traders, as well as from the service provider. To be more specific, the basic information includes the cost per power consumption of each power generation method, CO₂ emissions per power consumption of each power generation method, the amount of tax per power consumption of each power generation method (on a country or area basis), the unit price of a CO₂ credit on the emissions market, a fine if exceeding the cap, etc.

A unit price storage section (storage section) 103 stores the calculated unit price in the storage device 13 as print unit price information associated with identification information for identifying the printer system 4. The print unit price information may be stored as continuous values varying with time. Alternatively, the print unit price may be stored according to an index such as the number of jobs per unit time, including, in addition to the amount of money, attribute information to the print service environment in which the printer system 4 is provided. For example, the power generation method, the print job execution time slot, weather, etc., are stored as the attribute information.

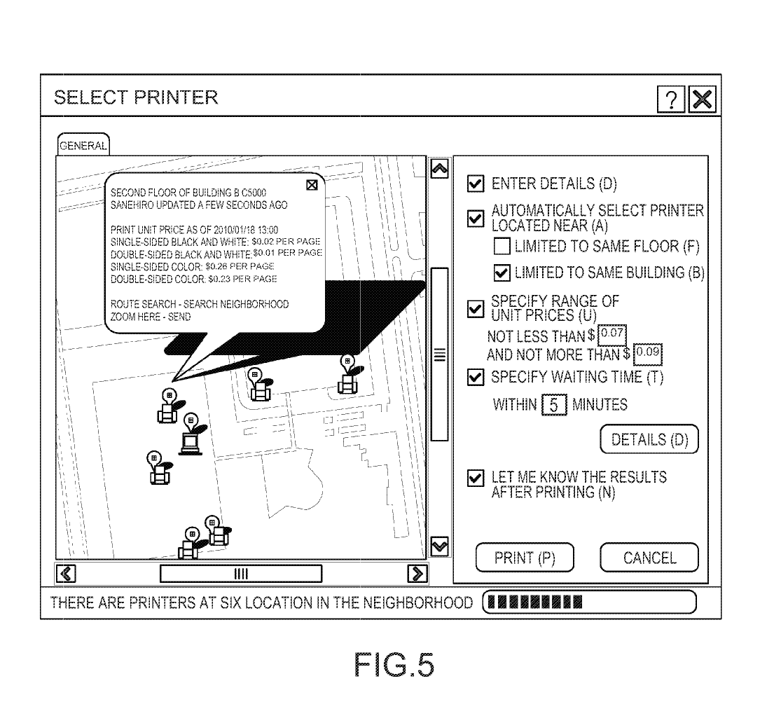

A print unit price sending section (sending section) 104 sends print unit price information according to the printing condition for each printer system 4 provided by the service provider, together with identification information for identifying the printer system 4. The printing condition may be preset or input from a user. Further, the printing condition may be accepted on a case-by-case basis. Printing conditions are described in greater detail below in reference to FIG. 5.

A user uses an application 200 on the client 3 to start a print job when desired. Since an application 200 is running on active clients 3, a print unit price receiving section (receiving section) 201 receives the print unit price information associated with identification information and sends the information to a selection accepting section 202. The selection accepting section 202 starts operating when the application 200 accepts input of a printing request.

The selection accepting section 202 accepts the selection of identification information for identifying a printer system 4 used by the service provider based on the print unit price information and identification information received. Specifically, a screen to select a printer system 4 is displayed to accept the selection. FIG. 5 is an illustration of a printer system selection screen in the cloud printing system according to the embodiment of the present invention.

In the example of FIG. 5, user input of printing conditions, such as “Printers in the neighborhood,” “Limited to the same building,” “Range of print unit prices is not less than $0.07 and not more than $0.09,” and “Waiting time is within 5 minutes,” is accepted as printing conditions, and the locations and identities of printer systems 4 that meet those printing conditions that are accepted, are graphically displayed together with identification information for identifying the printer systems 4, respectively. Detailed information on the printer systems 4 may be regularly displayed, or only when the position of a cursor to be displayed moves to the position at which each printer system 4 is displayed. The selection of a printer system 4 can be accepted when the user uses a mouse 25 to move the cursor onto the printer system 4 to be selected and click thereon.

To determine which printer systems 4 are displayed, the user may specify, on the client 3, conditions to extract the printer systems 4 available to execute the print job. In this case, the application 200 displays a condition entry screen (right side of FIG. 5), and a condition entry accepting section 205 accepts information on conditions for identifying a printer system 4 to execute the print job. A condition sending section 206 sends information on the conditions from the accepted entries to the print server 1.

A condition receiving section 108 of the print server 1 receives the information on the accepted conditions and sends the information on those accepted conditions to the job processing section 105. A printer system extracting section 106 in the job processing section 105 extracts, from among the available printer systems 4 connected through the network 2, a printer system 4 that satisfies the conditions received (if available) and acquires print unit price information associated with the extracted print system 4 from the unit price storage section 103.

As the information on the conditions whose entries from the user are accepted, information on environmental load such as power resources and CO₂ emissions is added to the information on conditions for identifying a printer system 4, as well as those conditions, for example, shown on the screen in FIG. 5, namely the information on conditions for identifying a printer system 4, such as “Printers in the neighborhood” and “Limited to the same building,” the amount of print job, a desired unit price range indicating, for example, that “The range of print unit prices is not less than $0.07 and not more than $0.09,” a desired delivery time such as “Waiting time is within 5 minutes,” etc.

The printer system extracting section 106 extracts a printer system 4 that satisfies the information on the conditions for identifying the printer system 4, and the job processing section 105 decides on the operating time of the printer system 4 required to complete the print job on the printer system 4 based on the size of print job. Further, the job processing section 105 calculates the print unit price for the operating time based on the desired unit price range to decide on candidates for the printer system 4. Printer systems 4 that do not satisfy the information on the conditions may be extracted as the secondary candidates.

The print unit price sending section 104 sends the print unit prices corresponding to the extracted printer systems 4 to the client 3 together with the identification of the extracted printer systems, and the selection accepting section 202 of the client 3 accepts the selection of a printer system from among the extracted printer systems 4, i.e., the selection accepting section 202 accepts the user's selection of a printer system 4 to execute the print job.

Returning to FIG. 4, when the selection accepting section 202 accepts the selection of one piece of identification information, i.e., when the selection accepting section 202 accepts the selection of a printer system 4, a print job generating section 203 generates a print job executable in the printer system 4, the selection of which is accepted, and sends the print job and the identity of the selected print system to the print server 1.

A job processing section 105 of the print server 1 receives the print job from the client 3 and schedules the print job according to the printing conditions. A user notification section 107 notifies the client 3 of the user of the processing results of the print job, and a result display section 204 of the client 3 displays the processing results of the print job to notify the user of the processing results.

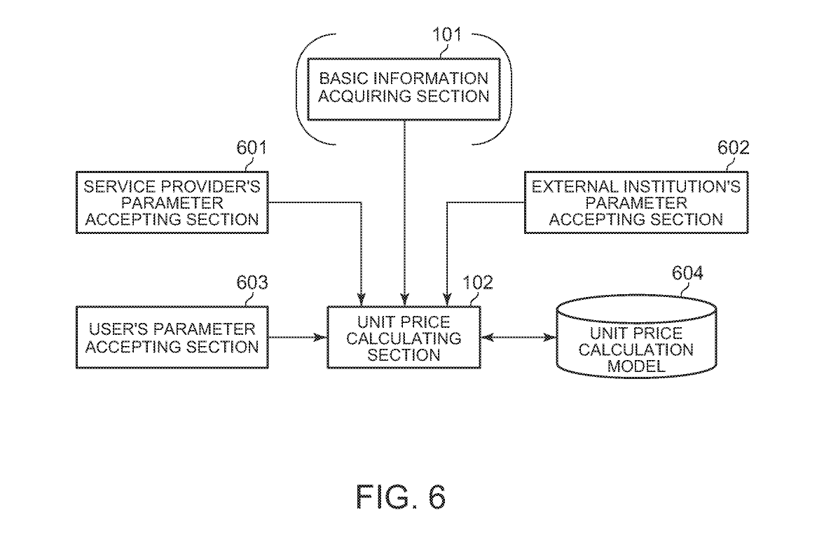

FIG. 6 is a conceptual diagram showing a flow of information acquired to enable the unit price calculating section 102 to calculate a print unit price in the cloud printing system, according to aspects of the present invention. All pieces of basic information are not necessarily limited to being acquired from the basic information acquiring section 101. Input of parameters from the service provider may be accepted in the printer system 4. Further, input of parameters from the user may be accepted on the client 3. Moreover, input of parameters from external institutions 40, such as an electric power company and CO₂ emissions traders, may be accepted on an external computer.

The parameters entered by the service provider are accepted by a service provider's parameter accepting section 601 and passed to the unit price calculating section 102. Parameters entered by the service provider include the power consumption on each printing condition, the percentage of each power generation method, the number of print jobs per unit time, the waiting time, information on a job scheduling policy, the consumable maintenance cost, and the like.

The parameters entered by an external institution 40 are accepted by an external institution's parameter accepting section 602 and passed to the unit price calculating section 102. The parameters entered by the external institution 40 include information on environmental load and the like, such as the unit price of electric power for each power generation method, the unit price of electric power in each time slot, the market price of trading electricity, the market price of CO₂ emissions trading, weather information, and taxation information.

The parameters entered by the user are accepted by a user's parameter accepting section 603 and passed to the unit price calculating section 102. The parameters entered by the user include information on a print job, such as the presence or absence of color printing, the presence or absence of both-sided printing, the paper quality, a desired unit price range, and a desired delivery time. These pieces of information are service level agreements set when a printer system 4 to execute the print job is selected.

The unit price calculating section 102 calculates a print unit price based on the above-mentioned parameters. For example, when the printer 42 in a printer system 4 is in an energy saving mode, the print unit price of the printer 42 is much higher than the printers 42 of the other printer systems 4 already activated. Further, since the longer the operating time of the printer 42, the more the deterioration of consumables is expected, the consumable maintenance cost will increase to increase the print unit price. In addition, continuous printing with the same size paper does not require that someone change the paper at the printer system 4, which can reduce the print unit price.

Similarly, because nuclear power has less CO₂ emissions, the higher the percentage of nuclear power powering the printer system 4, the lower the print unit price. The higher the percentage of printing at night, the lower the print unit price. Further, when there is an electricity shortage in summer, the price of electric power increases to increase the print unit price. In addition, the print unit price is cheaper in countries having more CO₂ emissions credits. Thus, the print unit price also varies according to the price of electric power, infrastructure costs, shipping charges, etc. in the country or area.

The print unit price is calculated as a unit price for a predetermined number of print jobs per unit time in view of these changing factors in deciding on the print unit price. The print unit price consists roughly of the following three parts: (1) the fixed cost, (2) the cost related to environmental load (e.g., CO₂ emissions), and (3) the rate of discount depending on the availability factor.

(1) The fixed cost can be calculated as the fixed cost required per print job by a method similar to a conventional print unit pricing method. (2) The cost related to environmental load, e.g., CO₂ emissions, can be calculated to include legislative fluctuation portions, such as power consumption, the amount of CO₂ emission upon execution of a print job, a fine if exceeding the cap, etc. (3) The rate of discount depending on the availability factor is determined depending on the amount of print job and the execution time slot.

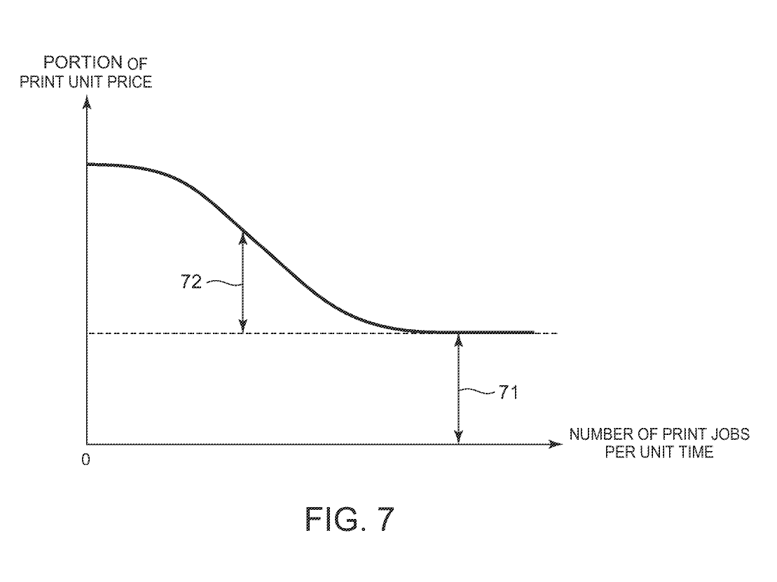

FIG. 7 is a graph illustrating the unit price calculation model 604. The unit price calculating section 102 that has acquired these parameters calculates a print unit price according to a unit price calculation model 604 stored in the storage device 13. In the example of FIG. 7, the portion of print unit price per number of jobs is plotted along ordinate and the number of print jobs per unit time is plotted along abscissa.

As shown in FIG. 7, the exemplary unit price calculation model 604 is set as the sum of a fixed cost 71 (i.e., the portion of print unit price fixed regardless of changes in the number of print jobs per unit time) and a varying cost 72 (i.e., the portion of print unit price varying according to the number of print jobs per unit time). In the example of FIG. 7, it is assumed that an increase in the number of print jobs will improve the usability of the resources of the printer system 4 and hence reduce the portion of print unit price. However, the example of FIG. 7 does not factor in a change in price of electric power, a concentration of print jobs, etc.

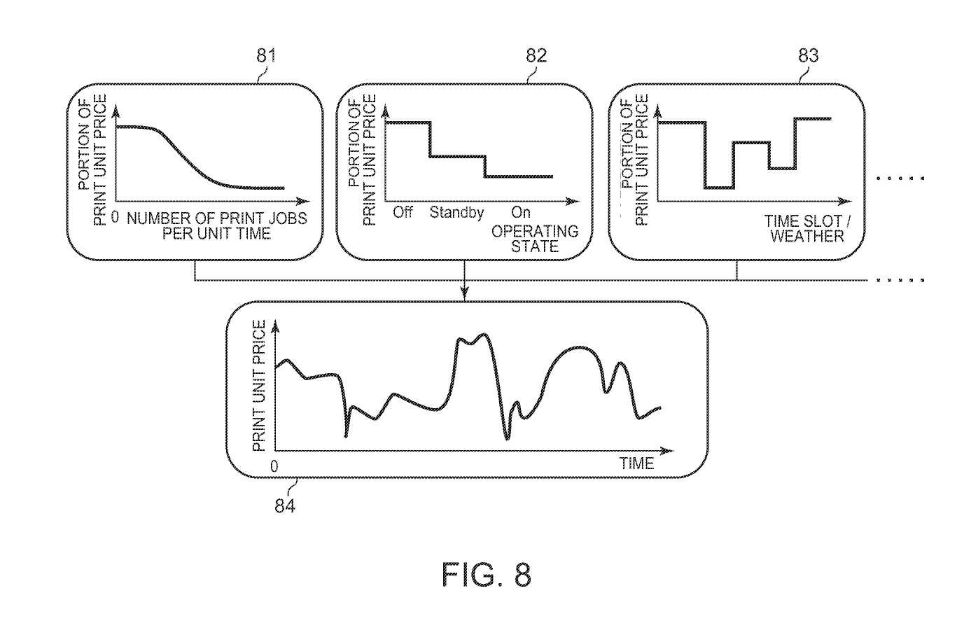

FIG. 8 contains graphs illustrating a case where multiple unit price calculation models are combined to determine one print unit price calculating model. In the example of FIG. 8, a unit price calculation model 81 similar to the unit price calculation model shown in FIG. 7; a unit price calculation model 82 based on power consumption associated with the operating status of the printer 42 in the printer system 4; a unit price calculation model 83 based on the price of electric power defined by the time slot, weather, etc.; and other multiple unit price calculation models are combined to determine one print unit price calculating model 84. Thus, a comprehensive print unit price calculating model 84 is determined by taking into account a print unit price in light of the environmental load, such as the unit price calculation models 82 and 83, rather than calculating a print unit price only from the simple printing cost.

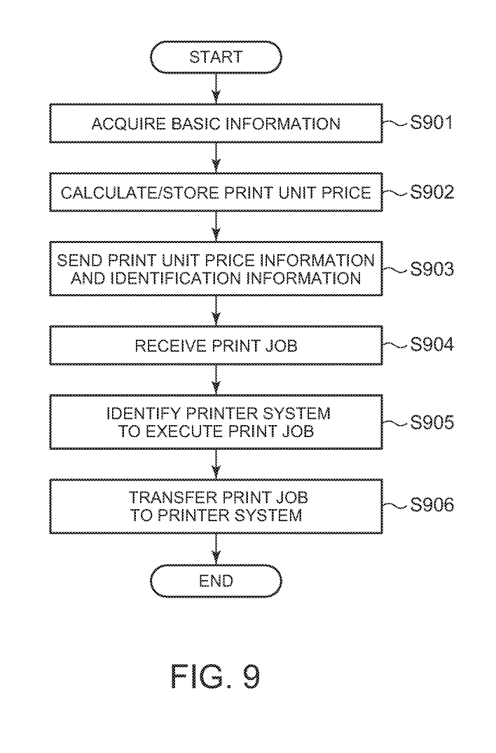

FIG. 9 is a flowchart showing a procedure performed by the CPU 11 of the print server 1 in the cloud printing system according to the embodiment of the present invention. In FIG. 9 at S901, the CPU 11 of the print server 1 searches the printer systems 4, external computers used by external institutions 40, or both to acquire basic information necessary to calculate each print unit price, such as the remaining amounts of consumables for each of the printer systems 4 in which the service provider provides print services, information on the operating status, the toner price, and the paper price, and basic information necessary to calculate each print unit price in consideration of environmental load. As mentioned above, the timing of acquiring the information is not particularly limited, but it is preferred to acquire the information periodically at constant time intervals in order to calculate the print unit price on which the environmental load is reflected substantially in real time. Alternatively, the information may be acquired when either of the basic information is updated.

At S902, the CPU 11 calculates and stores a print unit price for each printer system 4 based on the basic information acquired. The basic information can include the number of print jobs per unit time, waiting time, information on a job scheduling policy, the consumable maintenance cost, and the like, as well as information on the environmental load such as the power consumption on each printing condition and the percentage of each power generation method.

The calculated print unit price is stored in the storage device 13 as print unit price information associated with the identity of the associated printer system 4. The print unit price information is stored, for example, as continuous values on the time series plot or proportional to data volume, including attribute information to the environment of print services to provide the printer system 4, as well as the amount of money. For example, the power generation method, the time slot in which each print job is executed, weather, etc. are stored as the attribute information along with the print unit price.

At S903, the CPU 11 sends print unit price information corresponding to the printing conditions for each printer system 4 provided by the service provider together with the identity of the printer system 4. The printing conditions may be preset by the printing service provider or input from each user may be accepted on a case-by-case basis.

The CPU 11 receives a print job from the user's client 3 at S904, identifies a printer system 4 to execute the print job at S905, and schedules the print job according to the printing conditions. At S906, the CPU 11 transfers the print job to the printer system 4 according to the schedule.

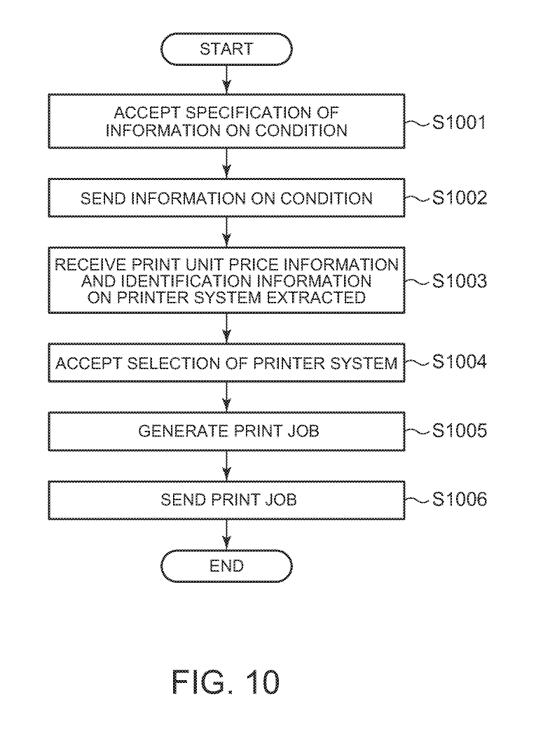

FIG. 10 is a flowchart showing a procedure performed by the CPU 31 of the client 3 in the cloud printing system according to aspects of the present invention. The user can enter conditions on the client 3 for identifying the printer system 4 to execute the print job. At S1001, the CPU 31 on the client 3 accepts the entry of information on conditions for identifying a printer system 4 to execute the print job). The entry of information on conditions may be accepted as an input on the selection screen for a printer system 4 shown in FIG. 5, or as input from a separate screen for accepting the entries of conditions. At S1002, the CPU 31 sends the information on conditions to the print server 1.

At S1003, the CPU 31 receives, from the print server 1, the print unit price information and the identification information of the printer systems 4 extracted according to the sent information on the conditions. At S1004, one of the printer systems 4 is selected, i.e., by accepting the selection of a printer system 4. The method of accepting the selection is similar as that described in the example of FIG. 5.

At S1005, the CPU 31 generates a print job, and at S1006 sends the print job and identification of the selected printer system 4 to the print server 1.

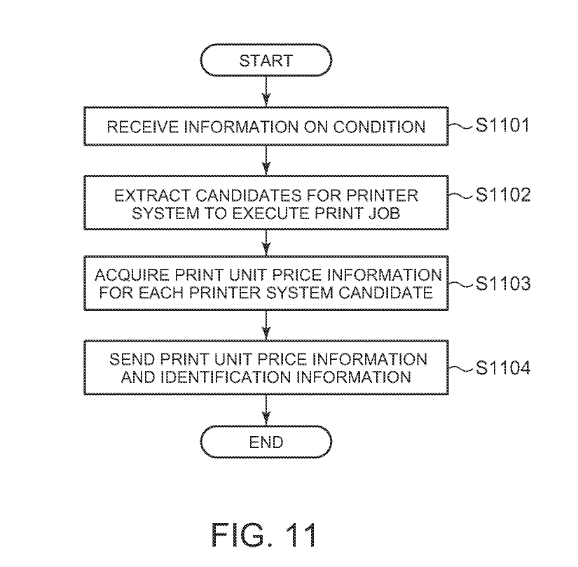

FIG. 11 is a flowchart showing a procedure performed by the CPU 11 of the print server 1 in the cloud printing system according to an aspect of the present invention. For instance, the flow of FIG. 11 can be executed in response to executing S1002 of FIG. 10. At S1101, the CPU 11 of the print server 1 receives the information on the conditions the entries of which are accepted and at S1102 extracts candidates for a printer system to execute the print job based on the received information on the conditions.

At S1103, the CPU 11 acquires, from the storage device 13, the print unit price information for each printer system candidate extracted, and at S1104 sends the client 3, the acquired print unit price information together with the identification information for identifying the printer system candidate.

Returning to FIG. 10, as described in greater detail above, the CPU 31 of the client 3 receives, from the print server 1, the print unit price information and identification information corresponding to each printer system 4 extracted according to the sent information on the conditions at S1003, and selects identification information from among the identification information received, i.e., accepts the selection of a printer system 4 to execute the print job at S1004. The method of accepting the selection is the same as that described in the example of FIG. 5.

The CPU 31 generates a print job at S1005, and sends the print server 1 the print job associated with the identification information for identifying the printer system 4 the selection of which is accepted at S1006.

As described above, the environmental load can also be reflected in calculating a print unit price, so that a balance between the improvement of usability of resources of the service provider and reduction in environmental load on the user can be achieved. Further, the user can acquire print unit prices, on which the environmental load is reflected substantially in real time, at predetermined timing, e.g., periodically, and this enables the user to select the optimum printer system 4 in consideration of the environmental load.

Note that aspects of the present invention are not intended to be limited to the aforementioned embodiment, and various changes and modifications can be made within the spirit of the present invention. For example, in the embodiment, a printer system 4 is selected from among candidates that satisfy the information on the conditions, but the present invention is not limited to the case where a particular printer system is selected to print out. The present invention may be to calculate, for each printer system 4, the degree of condition matching indicative of the degree of satisfying the information on the conditions so that the print server 1 will select a printer system 4 exhibiting the highest condition matching.

According to aspects of the present invention, printing cost can be changed as circumstances demand, such as the need to do emergency maintenance work, addressing a temporary decline in operational efficiency, responding to changes in cost due to the time slot, etc. As such, problems related to unreasonable printing cost caused, for example, by systems that calculate the printing cost as a fixed cost based on the past performance, are avoided.

Additionally, as CO₂ emissions trading becomes prevalent and hence smart grids and smart buildings become widespread, there is a strong demand for charging systems based on the environmental load such as to convert the CO₂ emissions into the cost. According to aspects of the present invention, the printing cost can be calculated in consideration of factors which may include, for example: the opportunity cost loss when a printer is not in use; CO₂ emissions during delivery of printed materials; the unit price of electric power; and CO₂ emissions during execution of a print job. Aspects of the present invention have been made in view of such circumstances, and thus systems and methods are disclosed herein, which are capable of selecting and providing an optimum printer system based on the print unit price on which dynamically varying environmental load is reflected. Aspects of the invention herein also disclose a print server used in a system for providing the optimum printer system, and a computer program capable of running on the print server.

In order to attain the above, an exemplary and illustrative system comprises a print server for selecting a printer system to execute a print job from among a plurality of printer systems connected to be able to perform data communication through a network and a client generating and sending the print job. The client is connected to be able to perform data communication with the print server through the network. The print server includes a basic information acquiring section for acquiring unit price calculation basic information on printer systems in operation including at least information on environmental load, a unit price calculating section for calculating a unit price for each printer system based on the unit price calculation basic information acquired, a storage section for storing the calculated unit price in association with identification information for identifying the printer system and a sending section for sending the print unit price and the identification information to the client. Moreover, the client includes a receiving section for receiving the print unit price and the identification information, a selection accepting section for accepting the selection of one piece of identification information from among the identification information received and a print job generating section for generating and sending a print job capable of being executed in the printer system corresponding to the identification information the selection of which is accepted.

In exemplary implementations, the client includes a condition entry accepting section for accepting an entry of information on a condition for identifying a printer system to execute the print job and a condition sending section for sending the print server the information on the condition the entry of which is accepted. In this regard, the print server includes a condition receiving section for receiving the information on the condition and a printer system extracting section for extracting a printer system that satisfies the information on the condition received. Here, the sending section sends the client identification information for identifying the extracted printer system and a corresponding print unit price. In yet further exemplary implementations, the unit price calculation basic information includes at least information on a market price of CO₂ emissions trading.

For instance, a print server, according to aspects of the present invention, may be connected through a network to be able to perform data communication with a client generating and sending a print job. The print server is configured for selecting a printer system to execute the print job from among a plurality of printer systems connected to be able to perform data communication through the network. In this regard, the print server comprises a basic information acquiring section for acquiring, at predetermining timing, unit price calculation basic information on printer systems in operation including at least information on environmental load. The print server also comprises a unit price calculating section for calculating a print unit price for each printer system based on the acquired unit price calculation basic information, a storage section for storing the calculated unit price in association with identification information for identifying the printer system and a sending section for sending the print unit price and the identification information to the client.

The print server may also and/or alternatively be configured to include a condition receiving section for receiving information on a condition for identifying a printer system to execute the print job and a printer system extracting section for extracting a printer system that satisfies the information on the condition received. The unit price calculation basic information includes at least information on a market price of CO₂ emissions trading.

According to still further exemplary aspects described more fully herein, printing in a system comprises a print server for selecting a printer system to execute a print job from among a plurality of printer systems connected to be able to perform data communication through a network and a client generating and sending the print job. The client is connected to be able to perform data communication with the print server through the network. The print server performs acquiring, at predetermining timing, unit price calculation basic information on printer systems in operation including at least information on environmental load, and calculating a print unit price for each printer system based on the acquired unit price calculation basic information. The print server also performs storing the calculated unit price in association with identification information for identifying the printer system and sending the print unit price and the identification information to the client. The client performs receiving the print unit price and the identification information, accepting the selection of one piece of identification information from among the identification information received and generating and sending a print job executable in a printer system corresponding to the identification information the selection of which is accepted.

Yet another illustrative method, performed by the client, comprises accepting an entry of information on a condition for identifying a printer system to execute the print job and sending the print server the information on the condition the entry of which is accepted. In this regard, the print server also performs receiving the information on the condition and extracting a printer system that satisfies the information on the condition received. As such, identification information for identifying the extracted printer system and a corresponding print unit price are sent to the client. According to further exemplary aspects, the unit price calculation basic information can include at least information on a market price of CO₂ emissions trading.

According to further aspects, a computer program is capable of running on a print server, connected through a network to be able to perform data communication with a client generating a print job, for selecting a printer system to execute the print job from among a plurality of printer systems connected to be able to perform data communication through the network. The computer program causes the print server to perform a basic information acquiring means for acquiring, at predetermining timing, unit price calculation basic information on printer systems in operation including at least information on environmental load, a unit price calculating means for calculating a print unit price for each printer system based on the acquired unit price calculation basic information, a storage means for storing the calculated unit price in association with identification information for identifying the printer system and a sending means for sending the print unit price and the identification information to the client.

A computer program may also be configured to cause the print server to function as a condition receiving means for receiving information on a condition for identifying a printer system to execute the print job and printer system extracting means for extracting a printer system that satisfies the information on the condition received. Again, as noted in greater detail herein, the unit price calculation basic information can include at least information on a market price of CO₂ emissions trading.

According to still further aspects, the environmental load can also be reflected in calculating a print unit price, so that a balance between the improvement of usability of resources of a service provider and reduction in environmental load on a user can be achieved. Further, the user can acquire print unit prices, on which the environmental load is reflected, at predetermined timing, e.g., periodically, and this enables the user to select the optimum printer system based on the acquired print unit prices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. Aspects of the invention were chosen and described in order to best explain the principles of the invention and the practical application, and to enable others of ordinary skill in the art to understand the invention for various embodiments with various modifications as are suited to the particular use contemplated.

What is claimed is:

1. A method of conducting printing, the method comprising:
acquiring, on a print server, basic information about printer systems connected to the print server including environmental load information;
calculating a print unit prices for the printer systems based on the acquired basic information;
storing the calculated unit prices along with identities of the printer systems associated with the calculated print unit prices; and
sending the print unit prices and the identities of the printer systems to a client.

2. The method according to claim 1 further comprising:
receiving a condition for extracting a printer system;
extracting a printer system that satisfies the received condition; and
sending the identity of the extracted printer system and a corresponding print unit price to the client.

3. The method according to claim 1, wherein acquiring environmental load information comprises acquiring information on a market price of carbon dioxide emissions trading.

4. The method according to claim 1, wherein acquiring environmental load information comprises acquiring information on a market price of carbon dioxide emissions trading.

5. The method according to claim 1, wherein acquiring the basic information comprises acquiring basic information at predetermined intervals.
